(19) United States
(12) Patent Application Publication
(10) Pub. No.: US 2024/0371618 A1
(43) Pub. Date: Nov. 7, 2024

(54) ANALYTICAL INSTRUMENT CALIBRATION

(71) Applicant: Thermo Fisher Scientific (Bremen) GmbH, Bremen (DE)

(72) Inventors: Daniel Marc Mourad, Bremen (DE); Bernd Hagedorn, Bremen (DE); Toby Shanley, Bremen (DE); Amelia Corinne Peterson, Bremen (DE)

(73) Assignee: Thermo Fisher Scientific (Bremen) GmbH, Bremen (DE)

(21) Appl. No.: 18/638,549

(22) Filed: Apr. 17, 2024

(30) Foreign Application Priority Data
Apr. 18, 2023 (GB) 2305645.0
Apr. 3, 2024 (GB) 2404759.9

(51) Int. Cl. H01J 49/00; H01J 49/40

(52) U.S. Cl. CPC H01J 49/0009; H01J 49/406

(57) ABSTRACT

A method of determining a calibration model for an analytical instrument comprises receiving mass spectral data, wherein the mass spectral data is generated by analysing one or more calibration samples using an analytical instrument; processing the mass spectral data to produce processed data indicative of one or more properties of the analytical instrument; and determining a calibration model for the analytical instrument by performing Gaussian Process Regression (GPR) on the processed data.

### CROSS REFERENCE TO RELATED APPLICATION

This application claims priority from application GB 2404759.9, filed Apr. 3, 2024, which claims priority from application GB 2305645.0, filed Apr. 18, 2023, both of which are incorporated herein by reference.

### FIELD OF THE INVENTION

The present invention relates to methods of determining calibrations for analytical instruments such as mass spectrometers and mass analysers.

### BACKGROUND

Analytical instruments such as mass spectrometers are commonly calibrated using one or more calibration curves. Calibration curves normally use deterministic models which may either be derived from first principles or deduced empirically. These models often lead to relatively simple closed-form expressions, from which a (preferably small) number of fit parameters can be deduced by means of regression on a set of experimentally recorded data points. These calibrations are inherently limited in their predictive power and figures of merit by both the underpinning theory of their models and availability of accurate, real-world data.

Furthermore, the application scope and predictive power of such derived calibration curves is inherently limited, either by the scope of validity of underlying theories or the availability of real-world data (including random or systematic errors). This data is not only used to obtain a best fit curve within a pre-defined parameter space but, in common practice, is also used to discriminate among different models with often competing theories for the initial physical data-generating mechanism.

It is believed that there remains scope for improvements to methods of determining calibrations for an analytical instruments such as mass spectrometers.

### SUMMARY

A first aspect provides a method of determining a calibration for an analytical instrument, the method comprising:
receiving mass spectral data, wherein the mass spectral data is generated by analysing one or more calibration samples using an analytical instrument;
processing the mass spectral data to produce processed data indicative of one or more properties of the analytical instrument; and
determining a calibration for the analytical instrument by performing Gaussian Process Regression (GPR) on the processed data.

Embodiments provide a Gaussian Process (GP) based data-driven method of determining parameter-free calibration curves for analytical instruments such as mass spectrometers. The application of a non-parametric approach in the GP framework to analytical instrument calibration workflows has several benefits, as described further below.

The step of determining a calibration for the analytical instrument may comprise calculating a calibration function by performing Gaussian Process Regression (GPR) using a covariance function on the processed data. The method may comprise choosing the covariance function to be used in the Gaussian Process Regression (GPR). The covariance function may be used to incorporate boundary conditions and generalisation properties of the solution, for example by optimisation of the correlation length of the underlying process.

Any suitable covariance function may be used. However, in particular embodiments, one or more of the Matérn covariance functions are used as the covariance function. As is described further below, these have been found to render improved results in the context of analytical instrument calibrations. The Matérn covariance functions are defined as:

$${K}_{M a t e r n} ( {x}_{i} - {x}_{j} ) = {\frac{{2}^{1 - v}}{Γ ( v )} [ \frac{\sqrt{2 v} ( {x}_{i} - {x}_{j} )}{l} ]}^{v} {K}_{v} [ \frac{\sqrt{2 v} ( {x}_{i} - {x}_{j} )}{l} ] ,$$

where Γ is the combinatoric Gamma function, l is the length scale and the underlying GP is ceil (v)−1 times differentiable. For learning and regression application cases, the

$$v = \frac{3}{2} and v = \frac{5}{2}$$

(“Matern32” and “Matern52”) functions are of most use.

The step of performing Gaussian Process Regression (GPR) on the processed data may comprise performing Gaussian Process Regression (GPR) on a difference between the processed data and a prior mean function. The method may comprise choosing the prior mean function to be used in the Gaussian Process Regression (GPR). The prior mean function may comprise a previously obtained calibration for the analytical instrument, e.g. a previously obtained calibration curve. Additionally or alternatively, the prior mean function may comprise an average of plural previously obtained calibrations for the analytical instrument. A significant increase in speed and accuracy can be achieved by using prior information e.g. in the form of a previously obtained calibration curve in the Gaussian Process Regression (GPR) process.

The calibration may be a calibration model. As used herein, a “calibration model” is a global model y(x1, x2, . . . ), which is a set of measurement values including their variation over the space of parameter values (x1, x2, . . . ). Such a model may be used, e.g., to control an instrument during its operation across the space of parameter values, and/or to correct data produced by an instrument. As used herein, a “calibration model” is not merely an optimum which can be described as a single value y(x1=x1ₒₚₜ, x2=x2ₒₚₜ, . . . ). The calibration may be in the form of a calibration curve or function, such as a correction curve or function.

The method may further comprise storing the determined calibration model, e.g. by storing data indicative of the determined calibration model. The calibration model may be stored in a manner that is suitable for later use to control the analytical instrument, to control another analytical instrument, to correct data produced by the analytical instrument, and/or to correct data produced by another analytical instrument. For example, the determined calibration model may be stored within a non-transitory computer readable storage medium accessible by the (and/or another) analytical instrument's control system, such as in a computer memory of the control system.

The method may further comprise using the calibration to determine one or more expected values, e.g. by interpolation and/or extrapolation. Thus, embodiments also extend to the use of the determined calibration. In general, to use the calibration model, a control system of an analytical instrument may (amongst other things) read the stored calibration model data from the memory in which the calibration model data is stored.

A second aspect provides a method of operating an analytical instrument comprising: using a calibration when operating the analytical instrument, wherein the calibration is determined by performing Gaussian Process Regression (GPR) on data produced using an analytical instrument.

For example, the analytical instrument may be operated using a plurality of operational parameters, and the step of using the calibration when operating the analytical instrument may comprise determining, using the calibration, the value(s) of one or more operational parameters to be used to operate the instrument (and then using the so-determined value(s) to operate the instrument). The one or more operational parameters can be any suitable operational parameters of the instrument (including any one or more or each of the parameters described herein), such as for example, a magnitude or amplitude of one or more DC or RF voltages, a frequency of one or more RF voltages, a pressure, a time or timing, and so on.

The method may comprise determining (and using) plural different value(s) of the one or more operational parameters from the calibration model during operation of the instrument. The method may comprise repeatedly determining (and using) different value(s) of the one or more operational parameters from the calibration model during operation of the instrument. That is, the method may comprise determining, using the calibration model, a plurality of different sets of the one or more operational parameter(s) for operating the instrument at each of a plurality of different times. For example, the method may comprise determining, using the calibration model, one or more first operational parameters for operating the instrument at a first time; and then determining, using the calibration model, one or more second different operational parameters for operating the instrument at a second different time. The method may comprise determining, using the calibration model, one or more third and/or further different operational parameters for operating the instrument at one or more third and/or further different time(s) (and so on).

A third aspect provides a method of processing mass spectral data generated by an analytical instrument, the method comprising:
receiving mass spectral data generated by analysing a sample with an analytical instrument;
processing the mass spectral data to produce processed data indicative of one or more properties of the sample; and
applying a calibration to the processed data, wherein the calibration is determined by performing Gaussian Process Regression (GPR) on data produced using an analytical instrument.

These aspects and embodiments can, and in embodiments do, include any one or more or each of the optional features described herein. Thus, for example, the calibration may be a calibration model, and may be determined in the manner described above with respect to the first aspect, and elsewhere herein.

Embodiments also extend to the use of the determined calibration to validate a calibration determined using a conventional model-based approach.

In these embodiments, the calibration model determined by performing Gaussian Process Regression (GPR) on the processed data may be a first calibration model, and the method may further comprise:
determining one or more second calibration model(s) for the analytical instrument by fitting one or more model function(s) to the processed data;
comparing the one or more second calibration model(s) to the first calibration model, and selecting one of the one or more second calibration model(s) for use based on the comparison.

The selected calibration model may then be stored, and used to calibrate an analytical instrument, e.g. in the manner described above.

Where the one or more second calibration model(s) comprise a single second calibration model, the method may comprise: based on the comparison, determining that that the single second calibration model is sufficiently similar to the first calibration model (and so is sufficiently accurate and should be used for calibration of the analytical instrument).

Alternatively, where the one or more second calibration models comprise a set of plural second calibration models, the method may comprise selecting one of the set of plural second calibration models for use based on the comparison. Each calibration model of the set of plural calibration models may differ from each other calibration model in the set in terms of (i) a model function used for the calibration and/or (ii) the value(s) of one or more fitting parameters derived from the calibration. The selected one of the set of plural second calibration models may be the one of the set of plural second calibration models that is determined to be most similar to the first calibration model.

The analytical instrument can be any suitable analytical instrument, such as a mass spectrometer, e.g. comprising an ion source and a mass analyser. The ion source may be configured to generate ions from a sample. The instrument may comprise one or more ion optical devices arranged between the ion source and the analyser, and may be configured such that ions can be passed from the ion source to the analyser via the one or more ion optical devices.

The one or more ion optical devices may comprise any suitable arrangement of one or more ion guides, one or more lenses, one or more gates, and the like. The one or more ion optical devices may include one or more transfer ion guides for transferring ions, and/or one or more mass selector or filters for mass selecting ions, and/or one or more ion cooling ion guides for cooling ions, and/or one or more collision or reaction cells for fragmenting or reacting ions, and so on. One or more or each ion guide may comprise an RF ion guide such as a multipole ion guide (e.g. quadrupole ion guide, hexapole ion guide, etc.), a segmented multipole ion guide, a stacked ring type ion guide, and the like.

The mass analyser can be any suitable mass analyser, such as a time-of-flight (ToF) mass analyser, an electrostatic ion trap mass analyser, an ion trap mass analyser, or a quadrupole mass analyser. The instrument may comprise a single such analyser or multiple analysers, such as both an electrostatic ion trap mass analyser, and a time-of-flight mass analyser, e.g. as described in U.S. Pat. No. 10,699,888.

In embodiments, the mass analyser is a ToF analyser configured to determine the mass to charge ratio (m/z) of ions from their arrival times. In general, the ToF analyser may comprise an ion injector arranged at the start of an ion path, and an ion detector arranged at the end of the ion path. The analyser may be configured to analyse ions by determining arrival times of ions at the detector (i.e., the time taken for ions to travel from the injector and to arrive at the detector via the ion path). The ion path may have any suitable form, such as being linear in the case of a linear ToF analyser, or including one or more reflections in the case of a ToF analyser comprising a reflectron or a multi-reflection time-of-flight (MR-ToF) analyser.

In particular embodiments, the analyser is a multi-reflection time-of-flight (MR-ToF) analyser, such as a titled-mirror type multi-reflection time-of-flight mass analyser, e.g. of the type described in U.S. Pat. No. 9,136,101, or a single focussing lens type multi-reflection time-of-flight mass analyser, e.g. of the type described in UK U.S. Pat. No. 2,580,089.

Thus, the analyser may comprise two ion mirrors spaced apart and opposing each other in a first direction X, each mirror being elongated generally along a drift direction Y between a first end and a second end, the drift direction Y being orthogonal to the first direction X. The ion injector may be located in proximity with the first end of the ion mirrors, and may be configured to inject ions into a space between the ion mirrors. The detector may be located in proximity with the first end of the ion mirrors, and may be configured to detect ions after they have completed a plurality of reflections between the ion mirrors. The analyser may be configured to analyse ions by injecting ions from the ion injector into the space between the ion mirrors, whereupon the ions may adopt a zigzag ion path having plural reflections between the ion mirrors in the direction X whilst: (a) drifting along the drift direction Y from the deflector towards the second end of the ion mirrors, (b) reversing drift direction velocity in proximity with the second end of the ion mirrors, and (c) drifting back along the drift direction Y to the deflector for detection.

The ion injector can be in any suitable form, such as for example one or more (e.g., orthogonal) acceleration electrodes. However, in particular embodiments, the ion injector comprises an ion trap. The ion trap may be configured to receive ions (from the ion source via the one or more ion optical devices), and may be configured to accumulate a packet of ions, e.g. by accumulating ions during an accumulation time period. The ion trap may be configured to inject each accumulated packet ions into the ion path (e.g. by accelerating the packet of ions along the ion path), whereupon the ions of the packet may travel along the ion path to the detector. The ion trap can have any suitable form, such as being an extraction trap, e.g. as described in UK U.S. Pat. No. 2,580,089.

In embodiments, the mass analyser is an electrostatic ion trap analyser, such as an electrostatic orbital trap mass analyser. The mass analyser may have an inner electrode arranged along an axis and two outer detection electrodes spaced apart along the axis and surrounding the inner electrode. Ions trapped within the mass analyser may oscillate with a frequency which may depend on their mass-to-charge ratio and which can be detected using image current detection. The ions may perform substantially harmonic oscillations along the axis in an electrostatic field whilst orbiting around the inner electrode. The mass analyser may be an Orbitrap™ mass analyser from Thermo Fisher Scientific. Further details of an Orbitrap™ mass analyser can be found, for example, in U.S. Pat. No. 5,886,346.

The mass analyser may instead be an ion trap mass analyser or a quadrupole mass analyser. Thus, the analyser may comprise an RF ion trap configured to release ions in order of mass to charge ratio (m/z) whereupon the ions travel to a detector for detection, or a quadrupole mass filter configured to filter ions according to their m/z wherein ions transmitted by the mass filter travel to a detector for detection. The detector may be configured to produce a signal indicative of an ion intensity received at the detector as a function of time.

In the method according to the first aspect, an analytical instrument is used to generate mass spectral data by analysing one or more calibration samples. In the method according to the third aspect, an analytical instrument is used to generate mass spectral data by analysing one or more analytical samples. Generating mass spectral data may comprise the ion source ionising one or more samples to produce ions, and the mass analyser mass analysing at least some of the ions so as to produce the mass spectral data. Suitable calibration samples and analytical samples are known in the art.

The calibration may be a calibration for any suitable property or properties of the analytical instrument and/or sample. Thus, the mass spectral data may be processed in any suitable manner to produce processed data indicative of any one or more suitable properties of the analytical instrument and/or sample.

For example, in some embodiments, the one or more properties comprises single ion area (SIA). In this regard, despite the areas of ion peaks produced by mass analysers such as ToF analysers typically having a pronounced dependence on the mass and/or charge of the ion, conventional mass spectrometers do not systematically correct for this mass and/or charge dependence. Thus, embodiments provide a calibration in the form of a correction function which describes the relationship between average single ion area and ion mass, m/z and/or charge across the entire operational mass, m/z and/or charge range(s) of a mass analyser. This allows systematic correction of the dependence of ion area upon mass and/or charge.

In these embodiments, the step of generating mass spectral data by analysing one or more calibration samples using an analytical instrument may comprise using the analytical instrument to analyse a plurality of single ions, wherein the plurality of single ions includes ions having masses, m/z and/or charge spread across most or all of mass, m/z and/or charge range(s) of interest for the instrument. The step of processing the mass spectral data to produce processed data indicative of one or more properties of the analytical instrument may comprise generating single ion area (SIA) data by determining the area of each ion peak of a plurality of ion peaks generated by the instrument in response to detecting the plurality of single ions. The step of determining a calibration for the analytical instrument may comprise determining a correction function by performing Gaussian Process Regression on the SIA data.

Similarly, a further aspect provides a method of determining a correction function for an analytical instrument, the method comprising:
using an analytical instrument to analyse a plurality of single ions, wherein the plurality of single ions includes ions having masses, m/z and or charge spread across most or all of mass, m/z and/or charge range(s) of interest for the instrument;
generating single ion area (SIA) data by determining the area of each ion peak of a plurality of ion peaks generated by the instrument in response to detecting the plurality of single ions; and
determining a correction function by performing Gaussian Process Regression on the SIA data.

In these aspects and embodiments, the step of receiving mass spectral data generated by analysing a sample with an analytical instrument may comprise receiving a signal generated by a mass analyser of the instrument, wherein the signal includes one or more ion peaks. The step of processing the mass spectral data to produce processed data indicative of one or more properties of the sample may comprise determining the area of a first ion peak of the one or more ion peaks. The step of applying a calibration to the processed data may comprise: estimating the number of ions that contributed to the first ion peak by: (i) determining a correction to be applied to the area of the first ion peak from a correction function, wherein the correction function describes a relationship between average single ion area and ion mass (m), mass-to-charge ratio (m/z) and/or charge (z) for the mass analyser; and (ii) applying the correction to the area of the first ion peak.

Similarly, a further aspect provides a method of analysing a signal generated by a mass analyser, the method comprising:
receiving a signal generated by the mass analyser, the signal including one or more ion peaks;
determining the area of a first ion peak of the one or more ion peaks; and
estimating the number of ions that contributed to the first ion peak by: (i) determining a correction to be applied to the area of the first ion peak from a correction function, wherein the correction function describes a relationship between average single ion area and ion mass (m), mass-to-charge ratio (m/z) and/or charge (z) for the mass analyser; and (ii) applying the correction to the area of the first ion peak;
wherein the correction function is determined by performing Gaussian Process Regression (GPR) on measured single ion area (SIA) data.

In these aspects and embodiments, one or more ion peaks are identified within the signal (mass spectral data), and then the area of one or more or each of the identified ion peak(s) is determined, e.g. by summing or integrating the area of the signal under the peak. For one or more or each ion peak, the number of ions that arrived at the detector in order to produce that peak is then estimated based on the area of the ion peak by applying a suitable correction to the ion peak area, e.g. by dividing (or multiplying) the ion peak area by a correction factor.

In these aspects and embodiments, the correction that is applied to a particular ion peak's area is determined from a correction function for the mass analyser. The correction function describes a relationship between average single ion areas (SIAs) and ion mass, mass to charge ratio (m/z) and/or charge for the analyser. In some embodiments, the correction function only describes the relationship between average single ion area (SIA) and ion mass or mass to charge ratio (m/z) for the analyser. In other embodiments, the correction function also (e.g. separately) describes the relationship between single ion area (SIA) and charge for the analyser. For example, the correction function may provide the approximate average area of an ion peak produced by the analyser in response to detecting a single ion as a function of the ion's mass or m/z (or equivalently as a function of the ion's velocity or arrival time) and optionally also as a function of the ion's charge.

The correction for a particular ion peak may be determined from the correction function by determining a mass or m/z (or equivalently a velocity or arrival time) associated with the ion peak and optionally a charge, and then determining the value of the correction function at the determined mass or m/z (or velocity or arrival time) and optionally charge. The so-determined value may be applied to the ion peak area (e.g. by dividing (or multiplying) the ion peak area by the value) to estimate the number of ions that contributed to the ion peak. Thus, the correction may correct for a mass and/or charge dependency of ion areas generated by the analyser.

The method according to these aspects and embodiments has particular benefits for time-of-flight mass analysers in which packets of ions are accumulated in an ion trap before being injected from the ion trap into a drift region of the analyser. In such analysers, it is often necessary to precisely control the total number of ions in each packet of ions accumulated in the ion trap, for example to optimise the number of ions to be below, but as close as possible to, a limit for the ion trap such as a space-charge limit for the ion trap. This is commonly done using so-called automatic gain control (AGC) methods, which can rely on precise measurements or estimations of the number of ions in a packet of ions to control the number of ions in a subsequent packet of ions. Each packet of ions can include ions spread over a wide range of masses and/or charge (and so with a wide range of corresponding SIAs), and so correcting for the dependence of ion area upon mass and/or charge can provide significant improvements to the accuracy of estimations of the number of ions in a packet of ions, and to AGC methods. Embodiments also or instead provide improved quantification of MS data.

In these aspects and embodiments, the detector of the mass analyser can be any suitable ion detector such as one or more conversion dynodes, optionally followed by one or more electron multipliers, one or more scintillators, and/or one or more photon multipliers, and the like. The detector may be configured to detect ions received at the detector, and may be configured to produce a signal indicative of an intensity of ions received at the detector as a function of (arrival) time. The detector can include a digitiser, such as a time-to-digital converter (TDC) or an analogue-to-digital converter (ADC), which may be configured to digitise each signal so as to produce a digitised signal. Thus, each signal that is generated by the analyser may be a digitised signal.

Each signal may include one or more ion peaks, such as a plurality of ion peaks, with each peak being generated by an ion (or plural ions having substantially the same mass to charge ratio (m/z)) detected by the detector. Each signal that is received and processed in embodiments may be produced from a signal in respect of a single packet of ions. Alternatively, each signal that is received and processed may be produced from the signal in respect of multiple packets of ions (i.e. multiple ion injections), whereby the multiple (digitised) signals are combined (e.g. averaged).

In the method, one or more ion peaks may be identified in a signal, e.g. using any suitable peak detection algorithm. The method may proceed by determining one or more characteristics of one or more or each identified ion peak, such as an ion peak's centroid and/or intensity, etc., e.g. by fitting a suitable peak model to the identified ion peak. Any suitable peak model may be used, such as for example a Gaussian or an asymmetric Gaussian. The one or more characteristics of each ion peak can be used as desired. For example, a physicochemical property associated with each ion peak, such as its mass, charge, and/or mass to charge ratio (m/z), may be determined using the one or more characteristics.

In the method, in addition to these characteristic(s), the area of one or more or each ion peak identified in the signal is determined. This may be done by summing or integrating the area of the signal under the peak (e.g. relative to a noise threshold) and/or by fitting a suitable ion peak model to the peak and determining the area of the ion peak model. The so-determined ion peak area is then used to estimate the number of ions that contributed to the ion peak, i.e. to estimate how many ions impacted upon the dynode of the ion detector in order to generate the ion peak. This is done by applying a correction to the ion peak area. The correction may be applied in any suitable manner, e.g. by dividing or multiplying the ion peak area by a correction factor, or by performing any equivalent operation(s).

Where multiple different ion peaks are identified in a signal (corresponding to ions with respective different masses or m/z), the method may comprise estimating the number of ions that contributed to each of the ion peaks by applying a respective different correction to each of the ion peaks. The estimated number of ions that contributed to each ion peak in the signal can then be summed to estimate the total number of ions that contributed to the signal, e.g. to estimate the total number of ions in the packet(s) of ions that generated the signal.

The correction function describes (at least) the relationship between average single ion areas (SIAs) and ion mass or m/z for the analyser. As used herein, a “single ion area” or “SIA” is the area of an ion peak generated by the analyser in response to detecting a single ion. The correction function can be or comprise a curve of average SIA as a function of mass or m/z (or equivalently as a function of ion velocity or arrival time). In particular embodiments, the correction function provides the (approximate) average SIA as a function of ion mass or m/z (or equivalently as a function of ion velocity or arrival time) for the analyser. Thus, the number of ions that contributed to a particular ion peak can be estimated by taking the average SIA from the correction function at the mass or m/z associated with the ion peak, and dividing the measured area of the ion peak by this value.

In embodiments, the correction function describes the relationship between average SIAs and ion mass or m/z for the analyser across a m/z range of interest for the analyser, such as across the entire operational m/z range of the analyser. As used herein the “operational m/z range” of the analyser is the range of ion m/z that the analyser is designed to analyse. In particular embodiments, the mass analyser is designed to analyse ions in life sciences applications, such as for example small and large organic molecules, biomolecules, DNA, RNA, proteins, peptides, fragments thereof, and the like. Thus, the correction function may describe the relationship between average SIA and ion m/z across a m/z range from about 25, 50, 75 or 100, to about 6000, 8000, 10,000, 15,000 or more. In some embodiments, the correction function describes the relationship between average SIA and ion m/z (at least) across a m/z range from about 50 to about 8000.

The correction function may be a function that is continuous over most or all of this m/z range, and the correction function may vary continuously over most or all of this m/z range. This allows systematic correction of the dependence of ion area upon mass or m/z in a particularly accurate and straightforwardly manner.

The correction function is determined by performing Gaussian Process Regression (GPR) on measured single ion area (SIA) data. In this regard, the inventors have realised that due to the large mass and/or charge parameter space and the inherent complexity of the molecular ions typically analysed in life science MS applications (e.g. including a large variety of different conformational structures), first principle analyses are not well suited to the present context. Thus, the correction function is derived by performing Gaussian Process Regression on experimentally acquired SIA data for the analyser. The experimentally acquired SIA data may comprise experimental measurements of SIA for an analyser for ions across most or all of the mass, m/z and/or charge range(s) of interest. The SIA data may comprise experimental measurements of SIA for ions of the same (e.g. single) charge. The SIA data may include plural measurements of SIA at each of plural different masses or m/z.

The SIA data to which the model is fitted can be acquired in any suitable manner. For example, it would be possible to acquire SIA data in respect of each and every individual analyser, and to derive the correction function for each respective analyser by fitting (parameters of) a model to the SIA data for that analyser. However, in particular embodiments, SIA data is acquired in respect of only one (or a few) particular representative analyser(s) of a class of analyser, and a global correction function is derived by fitting (parameters of) a model to that data. The global correction function may then be used as or to derive the correction function for one or more different analysers of the same class.

The SIA data to which the model is fitted can be raw SIA data recorded for the (representative) analyser(s). Alternatively, the raw SIA data can be suitably processed and/or corrected before the model is fit to the processed and/or corrected data. In embodiments, the mean of the SIA values for each given mass is determined, and the Gaussian Process Regression is performed on these mean SIA values.

It would be possible for the correction function to describe SIA as a function of mass or m/z only, e.g. where the analyser is to be used to analyse only ions of the same charge. However, in further embodiments, the correction function also describes a relationship between average single ion areas and charge for the analyser. For example, the correction function can be a surface describing average SIA as a function of mass or m/z (or equivalently as a function of ion velocity or arrival time) and charge. In particular embodiments, the correction function provides the (approximate) average SIA as a function of ion mass or m/z (or equivalently as a function of ion velocity or arrival time) and charge for the analyser. Thus, the number of ions that contributed to a particular ion peak can be estimated by taking the average SIA from the correction function at the mass or m/z and charge associated with the ion peak, and dividing the measured area of the ion peak by this value.

In embodiments, the correction function describes the relationship between average SIA and charge for the analyser across a charge range of interest for the analyser, such as from about 1 elementary charge, to about 10 elementary charges, 15 elementary charges, 20 elementary charges, or more. In particular embodiments, the correction function describes the relationship between average SIA and ion charge across a range from about 1 to about 15 elementary charges.

In these embodiments, the relationship between average single ion areas and charge may again be derived by performing Gaussian Process Regression on experimentally acquired SIA data for the analyser. The experimentally acquired SIA data may comprise experimental measurements of SIA for the analyser for ions across most or all of the charge range of interest. In particular embodiments, the model (and the correction function) simply increases linearly with charge.

Various further embodiments are possible. For example, in further embodiments, the one or more properties comprises a space charge induced mass measurement shift.

In time-of-flight (ToF) mass analysers, the flight time can change due to Coulombic interactions of the ions to be measured which results in a shift of the estimated mass-to-charge ratio. This is particularly the case for ToF analysers of the type where ions are first accumulated in an ion trap before being injected into the drift region of the ToF analyser. A parameterised model could be used to predict and compensate this shift based on the estimated number of charges N, the ion mass or m/z, and properties of the trap from which the ions are ejected. However, the origin of these errors is not well understood theoretically and poorly matches simulations of space charge effects, at least for optimised systems. Using the parameter free approach described herein is well-suited to overcoming these limitations. Thus, embodiments provide a correction function derived by applying GPR to experimentally acquired m/z shift data for a ToF-MS (or other MS) instrument.

In these embodiments, the step of processing the mass spectral data to produce processed data indicative of one or more properties of the analytical instrument may comprise generating mass (m/z) shift data by determining differences between the mass spectral generated by analysing the one or more calibration samples and mass spectral data for the one or more calibration samples that is known to be accurate, i.e. so as to produce measured m/z shifts across a m/z range of interest. This may be done for a range of ion abundances and for a range of trapping parameters, i.e. such that the mass shift data comprises measured m/z shifts as a function of m/z, ion abundance and trapping parameter(s). The step of determining a calibration for the analytical instrument may comprise determining a correction function by performing Gaussian Process Regression on the mass shift data.

Similarly, a further aspect provides a method of determining a correction function for an analytical instrument, the method comprising:
receiving mass spectral data, wherein the mass spectral data is generated by analysing one or more calibration samples using an analytical instrument;
generating mass shift data by determining differences between the mass spectral generated by analysing the one or more calibration samples and mass spectral data for the one or more calibration samples that is known to be accurate; and
determining a correction function by performing Gaussian Process Regression on the mass shift data.

Furthermore, in these aspects and embodiments, the step of receiving mass spectral data generated by analysing a sample with an analytical instrument may further comprise receiving and/or determining an ion abundance associated with the mass spectral data, and receiving and/or determining a value of at least one trapping parameter associated with the mass spectral data. The step of processing the mass spectral data to produce processed data indicative of one or more properties of the sample may comprise processing the mass spectral data to produce mass spectral data indicative of one or more ion peaks each having a mass to charge ratio. The step of applying a calibration to the processed data may comprise correcting the mass spectral data by: (i) determining, from a correction function and based on the ion abundance and the value of the at least one trapping parameter, a correction to be applied to each ion peak of the one or more ion peaks; and (ii) applying the correction to each of the ion peaks.

Similarly, a further aspect provides a method for correcting mass spectral data generated by a mass analyser, the method comprising:
receiving mass spectral data generated by the mass analyser, the mass spectral data indicative of one or more ion peaks each having a mass to charge ratio;
receiving and/or determining an ion abundance associated with the mass spectral data;
receiving and/or determining a value of at least one trapping parameter associated with the mass spectral data; and
correcting the mass spectral data by: (i) determining, from a correction function and based on the ion abundance and the value of the at least one trapping parameter, a correction to be applied to each ion peak of the one or more ion peaks; and (ii) applying the correction to each of the ion peaks.

The correction function may be determined by performing Gaussian Process Regression (GPR) on mass shift data, i.e. as described above.

These aspects and embodiments provide methods of correcting mass spectral data generated by a mass analyser. The mass analyser may again be a time-of-flight (ToF) mass analyser, e.g. as described above. The time-of-flight mass analyser may include an ion trap. The method may comprises accumulating a packet of ions in the ion trap, and mass analysing the packet of ions so as to generate the mass spectral data. The ion abundance associated with the mass spectral data may be or may be indicative of the total number of ions in the accumulated packet of ions. The one or more trapping parameters may comprise or may be indicative of a magnitude, amplitude A, and/or frequency of a trapping voltage, such as an RF voltage, applied to the ion trap when accumulating (and trapping) the packet of ions.

Upon receiving mass spectral data obtained from an analytical sample, a correction function is applied to the mass spectral data. The correction function may define mass shifts and a function of m/z. The mass spectral data may be indicative of one or more ion peaks each having a respective mass to charge ratio. One or more or each mass to charge ratio may be corrected by determining and applying a correction to that mass to charge ratio, e.g. by adding (or subtracting) a correction factor to that mass to charge ratio. Thus, applying the correction function to the mass spectral data may comprise shifting measured m/z values according to the mass shift defined by the correction function at that m/z.

In some embodiments, plural correction functions are defined for a suitable range of ion abundances and for a suitable range of trapping parameters. One correction function may be selected from the plurality of functions for use in correcting the mass spectral data based on the ion abundance N used when generating the mass spectral data and based on the trapping parameter (e.g. trapping RF amplitude A) used when generating the mass spectral data.

Alternatively, one correction function may be provided which defines correction values across a range of mass to charge ratios for a range of ion abundances and for a range of trapping parameter values, and the correction for a particular mass to charge ratio in particular mass spectral data having a particular associated ion abundance and a particular associated trapping parameter value may be determined from the correction function by determining the value of the correction function at the particular m/z, ion abundance and trapping parameter value. The so-determined value may be applied to the mass to charge ratio to correct the mass spectral data.

Where the mass spectral data is indicative of multiple different mass to charge ratios (corresponding to ions with respective different masses or m/z), the method may comprise correcting each mass to charge ratio by applying a respective different correction to each mass to charge ratio. The correction values may be shifts and applying the correction function to the mass spectral data may comprise adjusting the mass spectral data by at least one of the shifts. The correction values may be mass-to-charge ratio shifts for the mass spectral data.

Various further embodiments are possible. For example, in further embodiments, the one or more properties comprises a quadrupole RF voltage amplitude or frequency, a resolving DC voltage amplitude, and/or a DC/RF voltage ratio U.

In these embodiments, the analytical instrument comprises a quadrupole mass filter configured to filter received ions according to their m/z. The mass filter may be configured, when operating in a filtering mode of operation, to onwardly transmit only those ions having mass to charge ratios within a m/z transmission window. The width and/or the centre m/z of the transmission window are controllable (variable) by suitable control of RF and/or DC voltage(s) applied to the mass filter.

To establish a mapping between a desired m/z transmission window and the appropriate RF and DC voltages, the quadrupole mass filter is calibrated.

In embodiments, two sets of calibration parameters are defined and generated (per ion polarity and rod pair configuration). A “coarse” set of coefficients may be defined to establish a link between the required RF voltage and the theoretical RF voltage and requested isolation width, as well as the required resolving DC voltage and the theoretical DC voltage and theoretical DC/RF voltage ratio, U. The coarse coefficients effectively apply well-known quadrupole theory to the context of the instrument, and are sufficient for accurate low-resolution isolations, i.e. when the isolation width is relatively wide, e.g. ˜3 Th.

For narrower, or higher resolution isolations, a set of “fine” adjustment coefficients, generated from the collection of measurement data, may be applied, which represent the particular quadrupole's deviation from theory. These RF and U adjustment coefficients may take the form of RF and U correction values as a function of isolation centre m/z and isolation width. During instrument operation, the required RF and U correction values are returned for a requested isolation centre m/z and width.

When using conventional techniques, to ensure sufficient coverage of the mass-width correction space, such that accurate RF and U adjustment values are returned via interpolation during instrument operation, a large amount of data must be acquired. This may comprise the collection and analysis of the m/z transmission window for one or more range(s) of applied RF and DC voltages. Alternatively, a proxy for determining the m/z transmission window may be defined as an isolation profile. An isolation profile can be characterised by measuring the transmission of a single ion species with another mass analyser while scanning the transmission window centre m/z of the quadrupole.

In embodiments, GPR is applied to data measured in this way to obtain a suitable calibration. This reduces the measurement burden on a particular instrument (and overall calibration time), while also enabling estimation of regions with higher correction uncertainty.

Thus, in these embodiments, the step of generating mass spectral data by analysing one or more calibration samples using an analytical instrument may comprise measuring a plurality of quadrupole isolation profiles using the quadrupole mass filter. The step of processing the mass spectral data to produce processed data indicative of one or more properties of the analytical instrument may comprise determining a set of fine adjustment coefficients from the plurality of quadrupole isolation profiles. The step of determining a calibration for the analytical instrument may comprise determining a calibration for the analytical instrument by performing Gaussian Process Regression (GPR) on the set of fine adjustment coefficients. The calibration may be in the form of an RF calibration comprising RF adjustment correction values as a function of isolation centre m/z and isolation width, and a DC/RF voltage ratio (U) calibration comprising U adjustment correction values as a function of isolation centre m/z and isolation width.

Similarly, a further aspect provides a method of determining calibration for a quadrupole mass filter, the method comprising:
measuring a plurality of quadrupole isolation profiles the quadrupole mass filter;
determining a set of fine adjustment coefficients for the quadrupole mass filter from the plurality of quadrupole isolation profiles; and
determining a calibration for the quadrupole mass filter by performing Gaussian Process Regression (GPR) on the set of fine adjustment coefficients.

In these aspects and embodiments, numerous isolation profiles may be collected for m/z spanning a mass range of interest, at various isolation widths. A measured isolation centre and isolation width for each profile is determined. To find the corresponding RF and U correction factors between the measured points and coarse calibration-corrected values (i.e. the fine adjustment coefficients), the RF and U values from the centre of the measured isolation profile may be used. From these may be subtracted the calculated RF and U values given by the coarse calibration coefficients for the “true” isolation profile. These deltas then form correction factors, that along with the measured isolation width, comprise the fine adjustment coefficients.

A further aspect provides a non-transitory computer readable storage medium storing computer software code which when executed on a processor performs the method(s) described above.

A further aspect provides a control system for an analytical instrument such as a mass spectrometer, the control system configured to cause the analytical instrument to perform the method(s) described above.

A further aspect provides an analytical instrument, such as a mass spectrometer, comprising the control system described above.

A further aspect provides an analytical instrument, such as a mass spectrometer, comprising:
a mass analyser; and
a control system configured to cause the instrument to perform the method(s) described above.

These aspects can, and in embodiments do, include any one or more or each of the optional features described herein.

### DESCRIPTION OF THE DRAWINGS

Various embodiments will now be described in more detail with reference to the accompanying Figures, in which:

FIG. 1 shows schematically an analytical instrument in accordance with embodiments;

FIG. 2 shows schematically a multi-reflection time-of-flight mass analyser in accordance with embodiments;

FIG. 3A shows example results of ordinary least squares (OLS) regression on a set of 15 data points.

FIG. 3B shows example results of Gaussian Process Regression on the set of 15 data points used in FIG. 3A;

FIG. 4A shows the results of the Gaussian Process Regression of FIG. 3B.

FIG. 4B shows example results of a Gaussian Process Regression only 5 data points but using the results from FIG. 4A as prior information;

FIG. 5A shows example results of Gaussian Process Regression on a perturbed set of 5 data points;

FIG. 5B shows example results of Gaussian Process Regression on a perturbed set of 10 data points;

FIG. 5C shows example results of Gaussian Process Regression on a perturbed set of 15 data points;

FIG. 6 illustrates schematically a process of detecting ions in an ion analyser in accordance with embodiments;

FIG. 7A shows example results of Gaussian Process Regression and non-linear regression used to obtain a calibration curve for ion-electron conversion as a function of velocity;

FIG. 7B shows example results of Gaussian Process Regression and non-linear regression used to obtain a calibration curve for ion-electron conversion as a function of mass;

FIG. 8 shows example results of a non-linear fit used to obtain calibration curves for the correction of a space charge induced mass measurement shift;

FIGS. 9A-9D show quadrupole voltage correction surfaces in isolation centre m/z-isolation width space; and

FIG. 10 shows quadrupole RF correction surfaces from five randomly selected quadrupoles.

### DETAILED DESCRIPTION

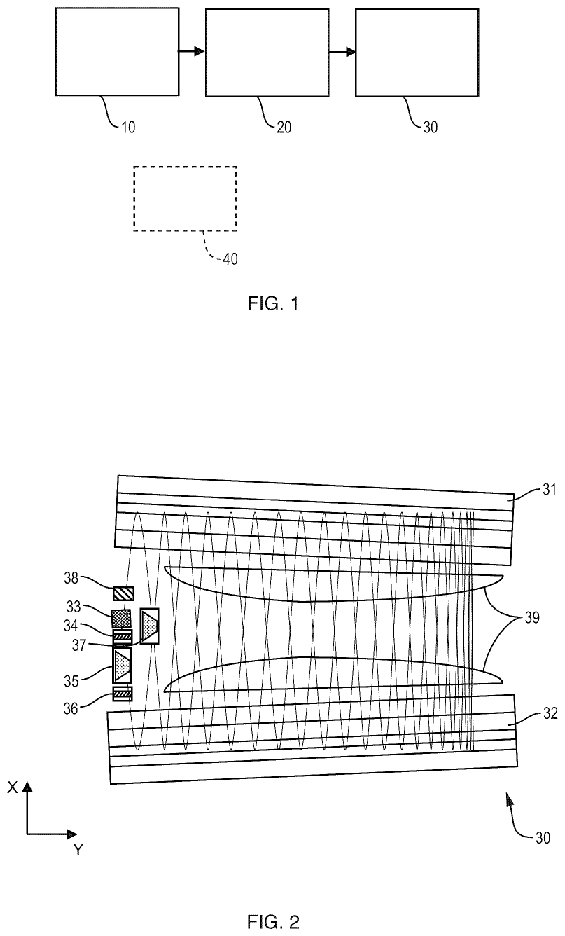

FIG. 1 illustrates schematically an analytical instrument, such as a mass spectrometer, that may be operated in accordance with embodiments. As shown in FIG. 1, the analytical instrument includes an ion source 10, one or more ion transfer stages 20, and an analyser 30.

The ion source 10 is configured to generate ions from a sample. The ion source 10 can be any suitable continuous or pulsed ion source, such as an electrospray ionisation (ESI) ion source, a MALDI ion source, an atmospheric pressure ionisation (API) ion source, a plasma ion source, an electron ionisation ion source, a chemical ionisation ion source, and so on. In some embodiments, more than one ion source may be provided and used. The ions may be any suitable type of ions to be analysed, e.g. small and large organic molecules, biomolecules, DNA, RNA, proteins, peptides, fragments thereof, and the like.

The ion source 10 may optionally be coupled to a separation device such as a liquid chromatography separation device or a capillary electrophoresis separation device (not shown), such that the sample which is ionised in the ion source 10 comes from the separation device.

The ion transfer stage(s) 20 are arranged downstream of the ion source 10 and may include an atmospheric pressure interface and one or more ion guides, lenses, traps and/or other ion optical devices configured such that some or most of the ions generated by the ion source 10 can be transferred from the ion source 10 to the analyser 30. The ion transfer stage(s) 20 may include any suitable number and configuration of ion optical devices, for example optionally including any one or more of: one or more RF and/or multipole ion guides, one or more ion guides for cooling ions, one or more mass selective ion guides, and so on.

The analyser 30 is arranged downstream of the ion transfer stage(s) 20 and is configured to receive ions from the ion transfer stage(s) 20. The analyser is configured to analyse the ions so as to determine a physicochemical property of the ions, such as their mass or mass to charge ratio. To do this, the analyser 30 is configured to pass ions to a detector. The instrument may be configured to determine the physicochemical property of the ions from a signal measured by the detector. The instrument may be configured produce a spectrum of the analysed ions, such as a mass spectrum.

The analyser 30 can be any suitable mass analyser, such as a time-of-flight (ToF) mass analyser, an ion trap mass analyser, or a quadrupole mass analyser.

In particular embodiments, the analyser 30 is a time-of-flight (ToF) mass analyser, e.g. configured to determine the mass to charge ratio (m/z) of ions by passing the ions along an ion path within a drift region of the analyser, where the drift region is maintained at high vacuum (e.g. <1×10⁻⁵ mbar). Ions may be accelerated into the drift region by an electric field, and may be detected by an ion detector arranged at the end of the ion path. The acceleration may cause ions having a relatively low mass to charge ratio to achieve a relatively high velocity and reach the ion detector prior to ions having a relatively high mass to charge ratio. Thus, ions arrive at the ion detector after a time determined by their velocity and the length of the ion path, which enables the mass to charge ratio of the ions to be determined. Each ion or group of ions arriving at the detector may be sampled by the detector, and the signal from the detector may be digitised. A processor may then determine a value indicative of the time of flight and/or mass-to-charge ratio (“m/z”) of the ion or group of ions. Data for multiple ions may be collected and combined to generate a time of flight (“ToF”) spectrum and/or a mass spectrum.

It should be noted that FIG. 1 is merely schematic, and that the analytical instrument can, and in embodiments does, include any number of one or more additional components. For example, in some embodiments, the analytical instrument includes a collision or reaction cell for fragmenting or reacting ions, and the ions analysed by the analyser 30 can be fragment or product ions produced by fragmenting or reacting parent ions generated by the ion source 10.

As also shown in FIG. 1, the instrument is under the control of a control unit 40, such as an appropriately programmed computer, which controls the operation of various components of the instrument including the analyser 30. The control unit 40 may also receive and process data from various components including the detector(s) in accordance with embodiments described herein.

The control unit 40 includes a memory configured to store (at least) a calibration model (i.e., data indicative thereof) as determined in accordance with embodiments. The stored calibration mode is for use in controlling the analytical instrument and/or in correcting data produced by the analytical instrument. As such, the control unit 40 may be configured to write data indicative of a calibration model as determined in accordance with embodiments to its memory and/or to read data indicative of a calibration model from its memory (and to then use the read calibration model data to control the analytical instrument and/or to correct data produced by the analytical instrument). As described elsewhere herein, the stored calibration model is a global model y(x1, x2, . . . ), which is a set of measurement values including their variation over the space of parameter values (x1, x2, . . . ). The stored calibration model is not merely an optimum which can be described as a single value y(x1=x1ₒₚₜ, x2=x2ₒₚₜ, . . . ).

FIG. 2 illustrates schematically detail of one exemplary embodiment of the analyser 30. In this embodiment, the analyser 30 is a multi-reflecting time-of-flight (MR-ToF) mass analyser.

As shown in FIG. 2, the multi-reflection time-of-flight analyser 30 includes a pair of ion mirrors 31, 32 that are spaced apart and face each other in a first direction X. The ion mirrors 31, 32 are elongated along an orthogonal drift direction Y between a first end and a second end.

An ion source (injector) 33, which may be in the form of an ion trap, is arranged at one end (the first end) of the analyser. The ion source 33 may be arranged and configured to receive ions from the ion transfer stage(s) 20. Ions may be accumulated in the ion source 33, before being injected into the space between the ion mirrors 31, 32. Ions may be trapped in the ion trap by applying suitable RF voltage(s), having a suitable amplitude A and frequency, to electrodes of the trap. As shown in FIG. 2, ions may be injected from the ion source 33 into the space between the mirrors 31, 32 with a relatively small injection angle or drift direction velocity, creating a zig-zag ion trajectory, whereby different oscillations between the mirrors 31, 32 are separate in space.

One or more lenses and/or deflectors may be arranged along the ion path, between the ion source 33 and the ion mirror 32 first encountered by the ions. For example, as shown in FIG. 2, a first out-of-plane lens 34, an injection deflector 35, and a second out-of-plane lens 36 may be arranged along the ion path, between the ion source 33 and the ion mirror 32 first encountered by the ions. Other arrangements would be possible. In general, the one or more lenses and/or deflectors may be configured to suitably condition, focus and/or deflect the ion beam, i.e. such that it is caused to adopt the desired trajectory through the analyser.

The analyser also includes another deflector 37, which is arranged along the ion path, between the ion mirrors 31, 32. As shown in FIG. 2, the deflector 37 may be arranged approximately equidistant between the ion mirrors 31, 32, along the ion path after its first ion mirror reflection (in ion mirror 32), and before its second ion mirror reflection (in the other ion mirror 31).

The analyser also includes a detector 38. The detector 38 can be any suitable ion detector configured to detect ions, and e.g. to record an intensity and time of arrival associated with the arrival of ion(s) at the detector. Suitable detectors include, for example, one or more conversion dynodes, optionally followed by one or more electron multipliers, and the like.

To analyse ions, ions may be injected from the ion source 33 into the space between the ion mirrors 31, 32, in such a way that the ions adopt a zigzag ion path having plural reflections between the ion mirrors 31, 32 in the X direction, whilst: (a) drifting along the drift direction Y towards the opposite (second) end of the ion mirrors 31, 32, (b) reversing drift direction velocity in proximity with the second end of the ion mirrors 31, 32, and then (c) drifting back along the drift direction Y to the deflector 37. The ions can then be caused to travel from the deflector 37 to the detector 38 for detection.

In the analyser of FIG. 2, the ions mirrors 31, 32 are both tilted with respect to the X and/or drift Y direction. It would instead be possible for only one of the ion mirrors 31, 32 to be tilted, and e.g. for the other one of the ion mirrors 31, 32 to be arranged parallel to the drift Y direction. In general, the ion mirrors are a non-constant distance from each other in the X direction along their lengths in the drift direction Y. The drift direction velocity of ions towards the second end of the ion mirrors is opposed by an electric field resulting from the non-constant distance of the two mirrors from each other, and this electric field causes the ions to reverse their drift direction velocity in proximity with the second end of the ion mirrors and drift back along the drift direction towards the deflector 37.

The analyser depicted in FIG. 2, further comprises a pair of correcting stripe electrodes 39. Ions travelling down the drift length are slightly deflected with each pass through the mirrors 31, 32 and the additional stripe electrodes 39 are used to correct for the time-of-flight error created by the varying distance between the mirrors. For example, the stripe electrodes 39 may be electrically biased such that the period of ion oscillation between the mirrors is substantially constant along the whole of the drift length (despite the non-constant distance between the two mirrors from). The ions eventually find themselves reflected back down the drift space and focused at the detector 38.

Further detail of the tilted-mirror type multireflection time-of-flight mass analyser of FIG. 2 is given in U.S. Pat. No. 9,136,101.

It should be noted that in general the analyser 30 can be any suitable type of mass analyser or time-of-flight (ToF) mass analyser. For example, the analyser may be a single-lens type multireflection time-of-flight mass analyser, e.g. as described in UK Patent No. GB 2,580,089.

Embodiments relate to methods of producing calibration curves for analytical instruments, such as the mass spectrometer of FIG. 1 and/or the mass analyser of FIG. 2. For notational simplicity, this disclosure refers to a one-dimensional function y=ƒ(x). In practice x=(x₁, x₂, . . . , xₙ) can have higher dimensionality and ƒ(x) can correspondingly represent an n-dimensional hyperplane.

Calibration curves that use deterministic models (which may either be derived from first principles or deduced empirically) usually lead to relatively simple closed-form expressions from which a (preferably small) number of fit parameters can be deduced by means of regression on a set of experimentally recorded data points. The application scope and predictive power of such derived calibration curves is inherently limited, either by the scope of validity of the underlying theories or the availability of real-world data (including random or systematic errors). This data is not only used to obtain a best fit curve within a pre-defined parameter space, but in common practice, is also used to discriminate among different models with often competing theories for the initial physical data-generating mechanism.

In addition, often no direct application advantages are gained by using a parametrised deterministic model in a closed form expression, as its only use is in predicting the most likely average value of a dependent variable y=ƒ(x) (the average measurement value) given a value for the independent variable(s) x, i.e., the noise-free set value(s). This can readily be achieved by having a y=ƒ(x) relationship available in any form (for example, a quasi-continuous lookup table would be sufficient, as would a more involved representation that is sufficiently close to the “true” ƒ(x), like a higher-order spline). The formulation of a “simple” model including determination of its parameters is just an intermediate step in the usual workflow, namely using standard software libraries to perform ordinary least squares (OLS) regression on a set of datapoints given a model in closed-form expression.

Furthermore, often no proper use is made of already available prior information from previous calibrations on the same instrument or another instrument besides eventual starting values for the parameter search in nonlinear regression to models.

Embodiments provide a Gaussian Process (GP) based data-driven method of determining parameter-free calibration curves for analytical instruments such as mass spectrometers. The application of a non-parametric approach in the GP framework to dedicated calibration workflows has several benefits, including:
1. The problem of defining parametrised model functions (e.g., ƒ(x)=a₀+a₁x+a₂x²+ . . . , ƒ(x)=a₀ exp (−a₁x)) as an intermediate step to obtain a ƒ(x) relationship is circumvented. In many applications, the ƒ(x) rather than the aᵢ values are used (lookup-like) after determining the set of parameters {aᵢ} by means of regression on experimental data and re-inserting them.
2. The approach is not limited by the scope of assumptions/first principles that underpin a model's function, but rather by the size of the recorded dataset (xᵢ, yᵢ). This is particularly useful in experimental practice, as there are often degrees of freedom independent of x that influence y but that can rarely be included with only a few model assumptions-such as for example, any measurable functions of mass-to-charge ratio m/z that depends on the conformity and/or chemical composition of ionised molecules.
3. The obtained solution usually interpolates and extrapolates the observations (xᵢ, yᵢ) in a reliable manner (in the scope of assumptions presented below) while not suffering from common deficiencies that occur for higher-order fits like problematic inter- and extrapolation properties (“Runge's phenomenon”).
4. The method uses a data-driven approach, i.e., seeks to find the relationship y=ƒ(x)+ϵ (with e as noise component) that has most likely generated the measured (xᵢ, yᵢ) data pairs (given a few reasonable constraints on the space of functions ƒ, as described below).
5. The method can incorporate prior information (e.g., a recorded curve from a previously performed calibration in the factory or from customers) to increase calibration accuracy with less data points. This use of prior knowledge can significantly speed up calibrations where scanning through the set values xᵢ constitutes a significant bottleneck, especially in the case of multi-dimensional problems.
6. The scope and validity of a model (e.g. used for instrument calibration) is usually determined during the research and development phase of an instrument with a very limited set of data. If unexpected effects are encountered during the release and production phase, or—more critically—during the long-term operation at the customer's site, such models need to be extended or re-developed, requiring collection of large new datasets and the application of software updates. The use of parameter-free calibration curves circumvents this problem to a considerable extent due to its data-driven nature.

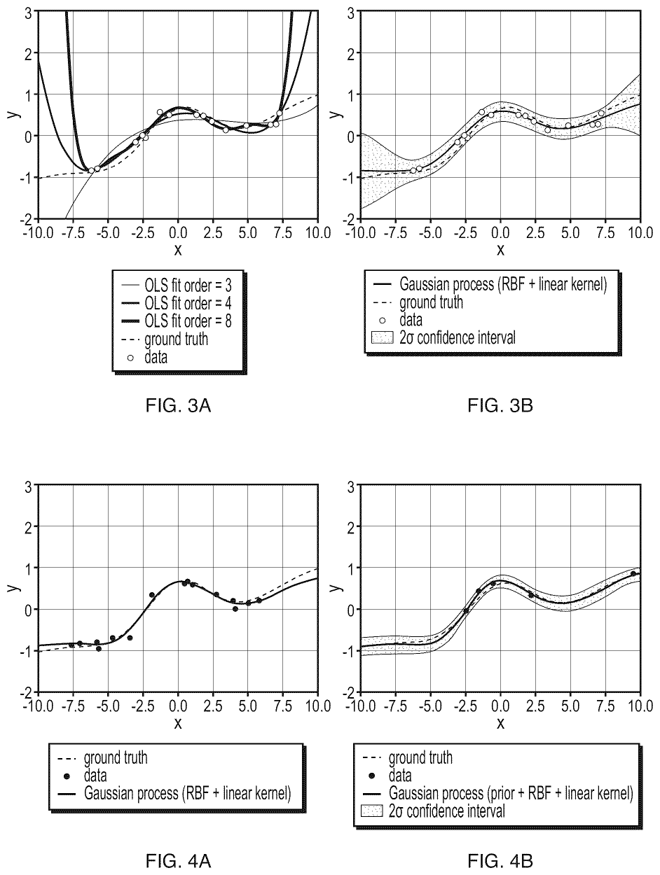

FIGS. 3A-3B show a set of 15 data points sampled from y=ƒ(x)+ϵ, where ƒ(x) is a smooth and well-behaving but unknown function (“ground truth”, GT) and ϵ is a Gaussian white noise component with a standard deviation of σ=0.1. FIG. 3A shows OLS regression curves assuming a 3rd, 4th and 8th order polynomial as the model function, respectively. Typical problems of higher-order polynomial fits can be identified like non-ideal inter- and extrapolation properties (“Runge's phenomenon”). FIG. 3B shows a non-parametrized Gaussian process regression curve including confidence intervals as obtained from Gaussian process regression with automatic hyperparameter optimisation (but without using prior information).

The following workflow typifies deterministic model calibration development:
1. Model selection and parametrization ƒ_{model}(x, aᵢ);
2. Determination of parameters aᵢ by using regression on acquired data points (xᵢ, yᵢ);
3. Recalculation of continuous y=ƒ_{model}(x, aᵢ) curve from parameters;
4. Use y=ƒ_{model}(x, aᵢ) to get expected yᵢ values for xᵢ not in the originally acquired set (inter- and extrapolation).

Embodiments circumvent error sources from step 1 in this workflow. A workflow according to embodiments is as follows:
1. Choice of correlation kernel (if necessary, see below);
2. Direct calculation of y=ƒ_{GP}(x) by Gaussian Process Regression (GPR) on acquired data points (xᵢ, yᵢ);
3. Use y=ƒ_{GP}(x) to get expected yᵢ values for xᵢ not in the originally acquired set (inter- and extrapolation).

A significant increase in speed and accuracy can also be achieved by using prior information (e.g., a previously obtained calibration curve) in step 2 of this workflow. Therefore, the same goodness-of-fit can be obtained with much less data, saving calibration time in the factory and for the customer.

This is illustrated by FIGS. 4A-4B. FIG. 4A shows the same GT function as in FIG. 3B, again simulating a GPR calibration on 15 data points. FIG. 4B shows another calibration curve using the result from the first calibration as prior information and then obtained by GPR using only 5 data points. To simulate a slight temporal or instrument “drift”, the GT curve has been rescaled to 90%. Still, very good agreement can be reached with the limited second data set.

### General Concept and Mathematical Framework

In a standard regression problem, the dependent variable y is modelled as a function of the independent variable(s) x plus irreducible noise, for example y=ƒ(x)=a₀+a₁x+ϵ in a one-dimensional linear regression model.

The basic idea in the GPR approach is to find a distribution over the possible functions ƒ(x) that agrees best with the available set of data points (xᵢ, yᵢ) by using Bayes theorem. It is also not desired to restrict the space of functions by limiting the number of possible parameters aᵢ. In that sense, the phrasing “parameter-free” might be misleading and one could rather speak of an “infinite number of parameters”.

If the entirety of unknown parameters is denoted with A and the entirety of observational data with Y, Bayes' theorem for the posterior distribution P(A|Y) (the probability of the model parameters A given the data Y) reads:

$$P ( A \vert Y ) = \frac{P ( Y \vert A ) P ( A )}{P ( Y )} ,$$

where P(Y|A) is the likelihood (the probability of the data given the model parameters) and P(A), P(Y) are the prior distributions (the probabilities for model A or data Y to manifest themselves without any given conditions, i.e. data or model, respectively). As P(Y) does not depend on the model parameters A, the following proportionality holds:

$$posterior ∝ likelihood \times prior ,$$

$$\begin{matrix}P ( A \vert Y ) ∝ P ( Y \vert A ) & P ( A )\end{matrix} .$$

In the framework of GPR, it is assumed that the prior distribution P(A) over the functions ƒ(x) is a Gaussian process, which means that samples from it follow a normal distribution at any point xᵢ. Sampling at a set of N different realisations of the independent variable x₁, . . . , x_{N} then leads to a N-variate Gaussian distribution for ƒ(x₁), . . . , ƒ(x_{N}). The Gaussian process itself is specified by two quantities, namely the prior mean function m(x) and the covariance kernel K(x, x′)=cov[ƒ(x), ƒ(x′)]:

$$f ( x ) ∝ GP [ m ( x ) , K ( x , {x}^{′} ) ] .$$

In the context of this disclosure, the prior mean function can be used to incorporate prior information (such as a curve obtained from a previous calibration). For simplicity, it is assumed to be zero, m(x)≡0, unless stated otherwise.

The covariance kernel (or kernel), on the other hand, can be used to incorporate boundary conditions and generalisation properties of the solution, for example by optimisation of the correlation length of the underlying process. This can be done by numerical auto-minimisation of the negative logarithm of the likelihood:

$$minimize \{ - log [ P ( Y \vert A ) ] \} ,$$

by varying hyperparameters of the kernel. For this purpose, there exists a variety of kernels with a differing number of hyperparameters, which can also be mutually combined.

The covariance, simply speaking, dictates how far input values x can be apart to still influence the output values y, thereby determining the smoothness of the function at the expense of the expected noise contribution. One of the standard kernels is the squared-exponential covariance function, also known as the RBF (radial basis function) kernel. Here, the covariance is modelled by a Gaussian-like function,

$${K}_{RBF} ( {x}_{i} , {x}_{j} ) = {σ}_{f}^{2} exp [ - \frac{1}{2 {l}^{2}} {( {x}_{i} - {x}_{j} )}^{2} ] + {σ}_{n}^{2} {δ}_{ij} ,$$

and the hyperparameters to be optimised given the measured data points (xᵢ, yᵢ) are the characteristic correlation length, the signal variance σ_{ƒ}² and the noise variance σₙ². The signal variance and diagonal noise variance entries can be suppressed in the notation (as they are equally applied in almost all kernels), hence the short-hand notation:

$${K}_{RBF} ( {x}_{i} , {x}_{j} ) = exp [ - \frac{1}{2 {l}^{2}} {( {x}_{i} - {x}_{j} )}^{2} ] .$$

Once the hyperparameters are fixed, the predictive distributions can be calculated (which represent the desired regression results). Denoting the result as ƒ_{GPR} and the set of N experimentally acquired data points as X, the expectation value and the covariance can be explicitly calculated:

$$\overline{{f}_{GPR}} = {K ( {X}^{′} , X ) [ K ( X , X ) + {σ}_{n}^{2} I ]}^{- 1} y ,$$

$$cov ( {f}_{GPR} ) = K ( {X}^{′} , {X}^{′} ) - {K ( {X}^{′} , X ) [ K ( X , X ) + {σ}_{n}^{2} I ]}^{- 1} K ( X , {X}^{′} ) .$$

ƒ̅_̅{̅G̅P̅R̅}̅ then represents the fit line, I is the identity matrix and the confidence intervals can be obtained from the diagonal elements of the N×N matrix \sqrt{diag[cov(ƒ_{GPR})]}, which approximate the standard error of the fit line at every x value.

### Choice of Correlation Kernels

The proper choice of a covariance kernel for any problem is an important step before GPR is applied to a specific class of problems. Although no specific model function must be specified in the GPR framework, consideration of general properties such as desired asymptotic behaviour of the regression curve, periodicities etc. will influence the kernel choice. Suitable kernel selection can significantly enhance the generalisation properties of the solution and enable GPR to obtain better fits and better inter- and extrapolations with less data points.

The plain RBF kernel (including its higher-dimensional generalisations) is most often used in Gaussian processes due to its analytical simplicity. However, the inventors have found it to carry some properties that render it less suitable for many realistic problems, especially for functions which are discontinuous in the first few derivatives and/or where the anticipated ground truth function shows ‘wiggles’ on different length scales (the GPR+RBF solution then tends to be dominated by the smallest length scale of the function, which will also hamper the extrapolation properties).

In many cases, the use of a generalisation class of the RBF kernel, the Matérn covariance functions, renders better results. They are defined as:

$${K}_{Matern} ( {x}_{i} - {x}_{j} ) = {\frac{{2}^{1 - v}}{Γ ( v )} [ \frac{\sqrt{2 v} ( {x}_{i} - {x}_{j} )}{l} ]}^{v} {K}_{v} [ \frac{\sqrt{2 v} ( {x}_{i} - {x}_{j} )}{l} ] ,$$

where Γ is the combinatoric Gamma function, l is again the length scale and the underlying GP is ceil (v)−1 times differentiable. For v→∞, provides the very smooth RBF kernel. For learning and regression application cases, the

$$v = \frac{3}{2} and v = \frac{5}{2}$$

(“Matern32” and “Matern52”) kernels are of most significance.

Commonly used scientific software packages like GPy or scikit-learn provide a large variety of kernels suitable for a vast range of applications. These premade covariance kernels can also be added (which roughly corresponds to an OR operation, i.e., the resulting kernel has a high/low value where either of the summands has a high/low value) and/or multiplied together (which corresponds to an AND operation).

### Choice of Prior Mean Function (Incorporation of Prior Information)

As already mentioned above, the prior mean function m(x) of the assumed GP can be used to incorporate prior information. This can be achieved by applying the GPR workflow to the difference between the measured data and the chosen prior mean function. The regression line is then given by:

$$\overline{{f}_{GPR}} = m ( {X}^{′} ) + {K ( {X}^{′} , X ) [ K ( X , X ) + {σ}_{n}^{2} I ]}^{- 1} [ y - m ( X ) ] , with {K}_{y} = K + {σ}_{n}^{2} I .$$

Although the art suggests that the generalisation properties (e.g., the extrapolation/asymptotic behaviour) of the solution should rather be tuned by the choice of suitable covariance kernels, the inventors have found in practice that it is often suitable to use the prior mean for that purpose if it is known with sufficient accuracy. This especially holds in the case that prior information is readily available, e.g., a previous calibration, and reduces the ambiguity of multiple solutions that arise from the use of different kernel combinations.

In machine learning-related classification problems of the art, where the size of the training data set is fixed, there is hardly any added benefit in using a non-constant prior mean function, as the applications commute (a non-constant prior mean can be added to the solution afterwards and the GT remains constant). The inventors have recognised that this is however different in instrument calibrations, where e.g., a temporal drift of the GT can make a recalibration necessary.

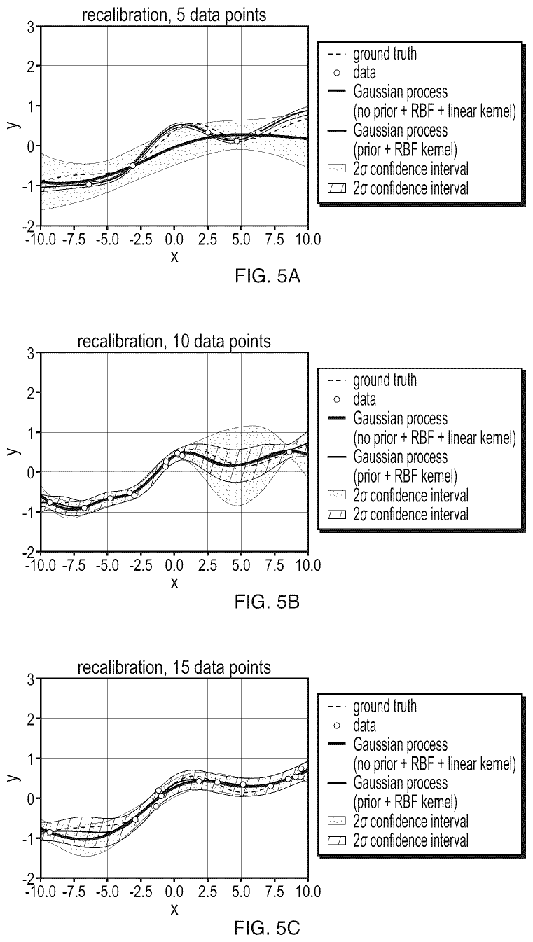

FIGS. 5A-5C provide an illustrative example. FIGS. 5A-5C show the same GT function as in FIGS. 3A-3B and FIGS. 4A-4B, again “recalibrated” after a perturbation of the GT (simulating a temporal drift of instrument properties). A stronger perturbation is used here than in FIGS. 4A-4B (80% rescaling and an additional shift of +1).

The violet line shows the results of a zero-mean prior combined with a more customised kernel. The red line shows the results of using a predictive mean from the original calibration as a prior mean for recalibration, combined with a standard RBF kernel. For a low number of recalibration data points, the use of a prior clearly outperforms the custom kernel. For a higher number of recalibration data points, the results of the two approaches converge.

A number of application examples will now be described. However, the scope of this disclosure is not intended to be limited to the applications listed below, and other applications are possible.

### Parameter Free Mass Dependent Correction of Ion-Electron Conversions

The GPR framework as presented here may be applied the problem of mass or, equivalently, velocity dependent corrections of single ion areas and subsequently estimated ion-electron conversions.

Time-of-flight (ToF) mass analysers with ion-impact detectors, such as the ToF analyser of FIG. 2, typically utilise the property that the travelling time of an ion in an electrostatic field is proportional to the square root of the ion's mass to charge ratio (m/z). Ions are ejected simultaneously from an ion source (e.g., an orthogonal accelerator or a radio-frequency ion trap), accelerated to a desirable energy, and impinge upon an ion detector after traveling a specified distance. Equally, in ion trap mass analysers and quadrupole mass analysers, ions eventually impinge upon an ion detector.

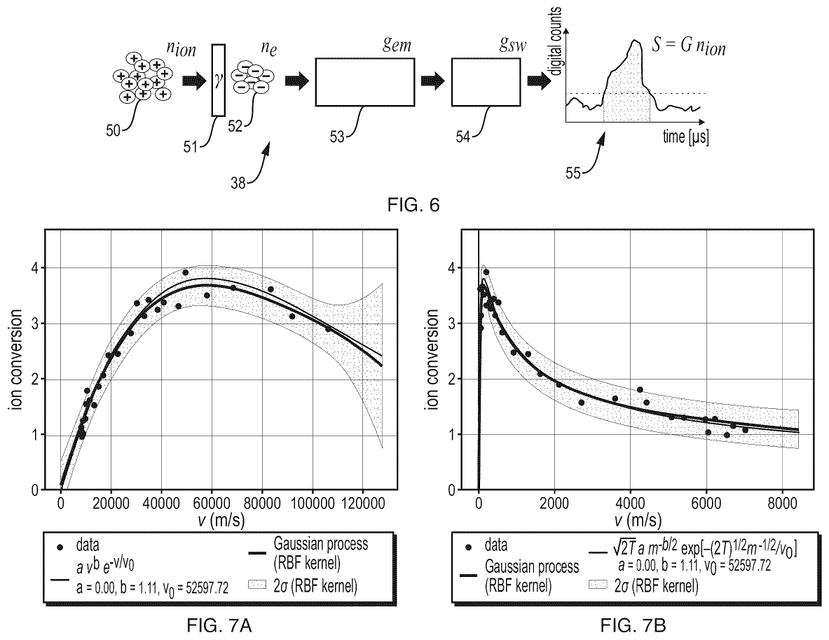

FIG. 6 illustrates schematically the process of a packet of nᵢₒₙ ions 50 being detected by the detector 38. In particular, FIG. 6 depicts the ion-to-electron conversion process and subsequent signal processing chain.

As shown in FIG. 6, the detector 38 comprises a conversion dynode 51 followed by one or more electron multiplier stages 53. A packet of nᵢₒₙ ions 50 is caused to impact upon the conversion dynode 51, whereupon ne secondary electrons 52 are produced. The packet of nᵢₒₙ ions is converted to ne secondary electrons with a conversion factor γ.

The secondary electrons 52 are then amplified by the one or more stages of electron multiplication 53, so as to produce a signal indicative of the intensity of the ions 50 received at the conversion dynode 51 as a function of time. The one or more stages of electron multiplication 53 provide a signal increase with gain factor gem.

The generated signal is recorded by data acquisition electronics 54 such as a digitiser, e.g. either a time-to-digital converter (TDC) or an analogue-to-digital converter (ADC). The analogue-to-digital conversion stage 54 introduces another gain factor g_{sw}.

In the embodiment depicted in FIG. 6, the detector 38 comprises a conversion dynode 51 followed by one or more electron multiplier stages 53. However, it should be noted that in general, the detector 38 may include one or more intermediate conversion processes additional to those shown in FIG. 6, such as for example, one or more scintillator crystals, photomultiplier tubes (PMT), etc.

As shown in FIG. 6, the detection process results in time resolved peaks 55, where each respective peak is generated by ions of substantially the same mass-to-charge ratio. For ToF analysers, as the travelling distance is substantially the same for all of the ions 50, the ion arrival time can be used to determine the mass-to-charge ratio (m/z) of the ions, which can then be used for ion identification.

Moreover, the area S of a time-resolved peak can be used to determine the number of ions that contributed to the peak, which can then be used for quantification. The final signal S is obtained by peak-wise integration of the digitized signal counts over the arrival time axis, and is designated herein as “ion area”, “ion peak area” (shaded region in FIG. 6) or, specifically, “single ion area” (SIA) in the limit nᵢₒₙ=1.

It has been recognised that the effective gain factor G between the integrated digitised signal S and the initial number of incident ions nᵢₒₙ (i.e. where S=Gnᵢₒₙ) is not constant, but bears a pronounced dependence on the statistical properties of the incident ions, the different conversion and amplification stages, as well as on the mass and charge state of the ions.

Despite literature and experimental evidence showing that the secondary electron yield (SEY) for ToF analysers has a pronounced dependence on ion mass and charge, existing mass spectrometers do not systematically correct for the mass and/or charge dependence of the ion-electron conversion process.

Thus, embodiments provide a correction function that can be used to correct for these mass and charge dependencies, and detection efficiencies. In particular, embodiments provide a correction function which describes the relationship between SIAs, ion mass and charge across the entire operational parameter space of a mass analyser. This allows systematic correction of the dependence of ion area upon mass and/or charge in a particularly accurate and straightforwardly manner.

In this regard, the inventors have recognised that the large mass and charge parameter space, and the inherent complexity (e.g. including their different conformational structures) of the molecular ions usually analysed using ToF analysers and other analysers in the area of the life sciences, makes it very unlikely that an analysis based on first principles is feasible for the problem at hand. Thus, embodiments provide a correction function derived by applying GPR to experimentally acquired SIA data for a ToF-MS (or other MS) instrument.

Firstly, for given acceleration and detector voltages, SIA data is recorded over a satisfactorily large mass range for singly charged species. Charge dependent data may also be acquired, e.g. for a selected set of ion masses. The mean values of the SIAs are then calculated for each given mass. These mean SIAs can be converted from the mass to the velocity domain using the kinetic energy equation

$$T = \frac{1}{2} m {ν}^{2} ⇔ v = \sqrt{\frac{2 T}{m}} ,$$

and the known acceleration voltage (which fixes T). A GPR is then performed on these means SIA data.

FIGS. 7A-7B show example mean SIA data (dots) as a function of velocity (FIG. 7A) and mass (FIG. 7B). FIGS. 7A-7B also illustrate the application of GPR (green line and confidence intervals) to obtain a calibration curve for the ion-electron conversion as a function of velocity v (FIG. 7A) or, equivalently, mass m (FIG. 7B). The GPR result was obtained using a standard RBF kernel, with automatic log-likelihood optimisation of the hyperparameters (and here without including any prior information). The red line shows, for comparison, the results of a non-linear regression using a variation of the Levenberg-Marquardt algorithm to obtain a best fit to the heuristic model curve av^{b} exp (−v/v₀) (or, equivalently,

$$\sqrt{2 T} a {m}^{- b / 2} exp [ - {( 2 T )}^{\frac{1}{2}} {m}^{\frac{1}{2}} / {ν}_{0} ] ) ,$$

i.e., a model with 3 free parameters (a, b, v₀).

When analysing analytical samples, the number of ions can now be approximately obtained using this curve, e.g. as the measured peak area divided by the best fit SIA(m) for any measured mass of interest. A correction for charge state z can optionally also be applied.

This may involve identifying a particular (“ith”) ion peak in the digitised signal produced by the detector 38, and determining its peak area Sis, e.g. by integrating the area of the signal under the peak. The mass m′ of the ith ion peak is also determined, optionally together with its charge z. The mass to charge ratio (m/z) of an ion peak can be determined from its arrival time, its charge z can be determined from the context of the experiment and/or by considering related isotope patterns and/or adjacent charge state ion peaks, and its mass m can be determined from its m/z and charge z.

Next, the mass m′ and/or charge zᵢ of ith ion peak is or are used to look up a correction factor SIA(m′, z) for the ion peak from the correction function SIA(m, z) (which is produced in the manner described above). Finally, the number of ions nᵢₒₙ that contributed to the ith ion peak is determined by dividing the ion peak area S by the correction factor SIAⁱ(mⁱ, zⁱ), i.e.

$${n}_{ion}^{i} = \frac{{S}^{i}}{{SIA}^{i} ( {m}^{i} , {z}^{i} )} .$$

This process of determining the number of ions that contributed to an ion peak can be repeated for one or more or each other ion peak in the signal. The so-estimated number of ions that contributed to each ion peak in the signal can then be summed to estimate the total number of ions that contributed to the signal, e.g. to estimate the total number of ions in the packet(s) of ions that generated the signal.

This information can be used for quantification, e.g. of particular analytes in the sample. Additionally or alternatively, the information can be used for so-called automatic gain control (AGC) methods.

### Correction of Space Charge Induced Mass Measurement Shift

In time-of-flight (ToF) mass spectrometers, the flight time can change due to the Coulomb interaction of the ions to be measured which results in a shift of the estimated mass-to-charge ratio. This is particularly the case for ToF analysers of the type depicted in FIG. 2, where ions are first accumulated in an ion trap 33 before being injected into the drift region of the ToF analyser.

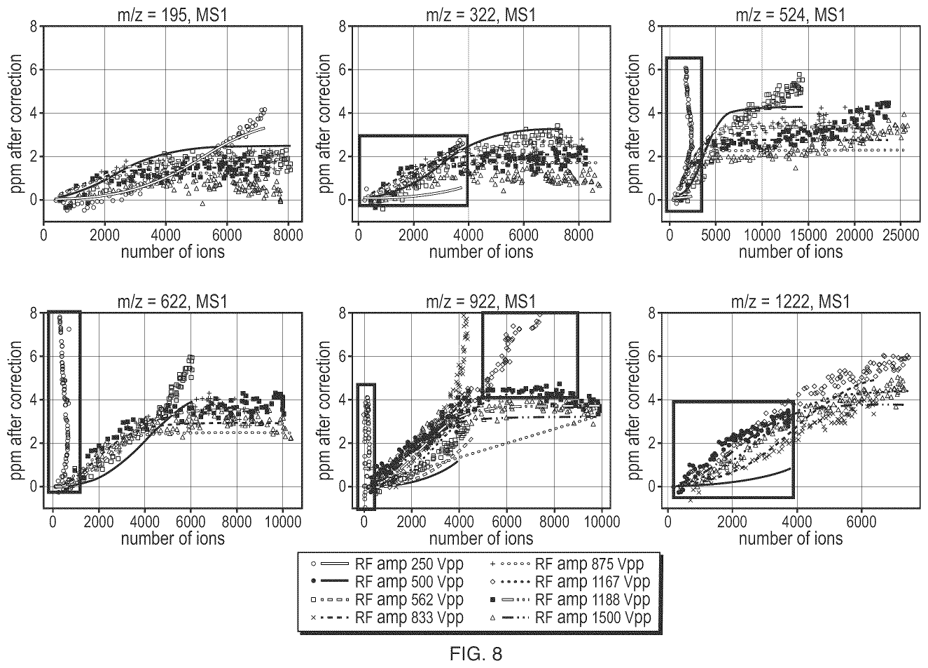

FIG. 8 shows m/z shift trends measured using an analyser of the type depicted in FIG. 2 for several Pierce™ FlexMix™ ions injected together at differing RF trapping amplitudes A. The RF trapping amplitude A is the amplitude of the RF voltage applied to the ion trap 33 in order to trap ions within the ion trap 33 (as described above). FIG. 8 shows differing m/z shift trends for co-injected Pierce™ FlexMix™ ions at different ion loads N and trap RF amplitudes A (in Volts) without any kind of correction being applied. It can be seen that there are both m/z-related effects and RF-related effects. Generally, a high trapping RF amplitude A causes a levelling off of m/z to occur at a lower total ion number N, consistent with the idea that increased initial charge density under stronger trapping RF causes self-bunching to occur earlier. It is however apparent that isolated ions, which should be most tightly RF focused, reach a ˜25% higher mass shift before levelling off.

Another observation is that at low trapping RF amplitude A, weakly trapped ions follow a different m/z shift behaviour completely and seem to track the total ion population in the ion trap. These ions suffer most strongly from space charge effects within the trap 33, and the effect seems to occur when the pseudopotential well depth is approximately <1.5 eV.

A parameterised model could be used to predict and compensate this shift based on the estimated number of charges N, the ion mass or m/z, and properties of the trap 33 from which the ions are ejected. However, the origin of these errors is not well understood theoretically and poorly matches simulations of space charge effects, at least for optimised systems. Using the parameter free approach described herein is well-suited to overcoming these limitations. Thus, embodiments provide a correction function derived by applying GPR to experimentally acquired m/z shift data for a ToF-MS (or other MS) instrument.

The m/z shift data may be determined for a given ion abundance N and for a given trapping RF amplitude A by analysing a calibration sample using the given ion abundance N and the given trapping RF amplitude A, and determining differences between the so-obtained mass spectral data and known mass spectral data for the calibration sample. This may be repeated for various ion abundances N and trapping amplitudes A, e.g. across a suitable range of ion abundances N (e.g. between about 10 and 10,000 ions) and a suitable range of trapping amplitudes A (e.g. between about 200 Vpp and 2,000 Vpp). The mass spectral data may have a suitable mass range (e.g. between about 100 Th and 1500 Th).

GPR may be applied to the entirety of acquired data points to obtain a calibration, e.g. in the form of a best-fit hyperplane. This best-fit hyperplane may then be used to correct mass spectral data acquired when analysing an analytical sample by determining a correction function to be applied to the mass spectral data by evaluating the best-fit hyperplane at desired point(s) in the (m/z, N, A) space, and applying the determined correction function to the mass spectral data.

FIG. 8 also shows calibration curves as obtained from a non-linear fit to a generalised logistic function (dependent on mass-to-charge ratio m/z, ion number N and RF amplitude A) used for the correction of space charge induced mass measurement shift. While the model gives good results for the most part, it is clearly identifiable that the total set of data points has a highly non-trivial functional dependency on the 3-tuple of independent variables (m/z, N, A), and the global best fit solution (solid lines for fixed m/z and A) locally leads to large residuals and thus root-mean-square deviations from the best fit model hyperplane (see the boxed regions). Thus, the model seems to correctly describe the observed shift in most cases. However, the model is purely heuristic and may not capture all aspects of the space-charge induced mass shift. For extreme settings of the trap, the model fails to describe the observed shifts.

Using the parameter free approach described herein is well-suited to overcome these limitations. As the underlying calibration problem is reducible to a look-up table for the mass correction given the 3 settings, it may be improved by GPR on the entirety of acquired data points, where the resulting best-fit hyperplane is then evaluated at any desired point in the (m/z, N, A) space.

### Model Validation

In some cases, there may be technical or organisational reasons to still use a model-based regression workflow. For example, an instrument may utilise a data format that expects model-specific parameters to be provided instead of a quasi-continuous ƒ(x) curve. In such cases, the results of a model free GPR analysis may be used as a means for model validation. For example, the GPR results may be used to discriminate among different parameter sets and/or between different models, e.g. by comparing the model-derived fit lines and predictions to the GPR results.

In the scope of the assumptions of Gaussian processes, the GPR results represent the process most likely generating the data. The assumptions entering the GPR framework are, however, not very limiting, as they are a subset of the assumptions also made in the standard linear and nonlinear regression workflows (non-correlated and normally distributed noise with constant variance).

For example, in the above-mentioned example of ion conversions, this model validation approach was used to see whether a quadratic velocity dependence in the exponent,

$$a {ν}^{b} exp ( - \frac{{ν}^{2}}{{ν}_{0}} ) ,$$

would lead to results “more likely” fitting the data. This assumption was then rejected in favour of the simpler linear dependency, as the v² dependency did not yield a better agreement to the GPR fit line.

### Fine Correction of Quadrupole Calibration

Analytical instruments, such as the mass spectrometer depicted in FIG. 1, often use a quadrupole mass filter to isolate ions having particular mass-to-charge (m/z) ratios. A quadrupole mass filter comprises four parallel, elongated typically cylindrically- or hyperbolically-milled electrodes containing one or more segments, arranged as two sets of opposing rod pairs around a central axis. RF and DC voltages are applied to electrically-connected opposing rod pairs, wherein an attractive DC voltage that is attractive to the ions is applied to one pair of opposing electrodes and a repulsive DC voltage that is repulsive to the ions is applied to the other pair of opposing electrodes. These attractive DC and repulsive DC voltages are collectively known as the resolving DC. An RF voltage is applied to one pair of opposing electrodes, while an equal and opposite phase RF voltage is applied to the other pair of opposing electrodes.

To operate the device as a mass filter and thereby isolate ions having a limited range of mass-to-charge ratios, particular RF and resolving DC voltages are applied, which are controlled by electronics and depend on the mass filter geometry and dimensions. To establish a mapping between a desired range of m/z to be isolated and the appropriate set voltages, the quadrupole mass filter needs to be calibrated.

Establishment of the quadrupole calibration relies upon the collection and analysis of the range of m/z transmitted by the quadrupole for a given set of applied voltages. A proxy for determining the range of m/z that would be transmitted by the quadrupole may be defined as an isolation profile. An isolation profile can be characterised by measuring the transmission range, or isolation width measured at half-height of the isolation profile, while scanning the centre of an isolation range, or isolation centre m/z, and detecting, typically with a second mass analysis device, a single ion species.

Collecting data and analysing the resultant isolation profile accurately enough to achieve an acceptable calibration (or for other purposes) can be time consuming.

In embodiments, two sets of calibration parameters may be defined and generated (per ion polarity and rod pair configuration). A “coarse” set of coefficients may be defined to establish a link between the required RF set voltage and the theoretical RF voltage and requested isolation width, as well as the required resolving DC set voltage and the theoretical DC voltage and theoretical DC/RF voltage ratio, U. The coarse coefficients effectively apply well-known quadrupole theory to the context of the instrument, and are sufficient for accurate low-resolution isolations, i.e. when the isolation width is relatively wide, ˜3 Th.

For narrower, or higher resolution isolations, a set of “fine” adjustment coefficients, generated from the collection of a large amount of measurement data, may be applied, which represent the particular quadrupole's deviation from (contextualized) theory. These RF and U adjustment coefficients may take the form of a look-up table indexed by isolation centre m/z and isolation width. During instrument operation, the required RF and U adjustment values for a requested isolation centre m/z and width may be determined via linear interpolation of the nearest four points (in m/z and width space) in the look-up table.

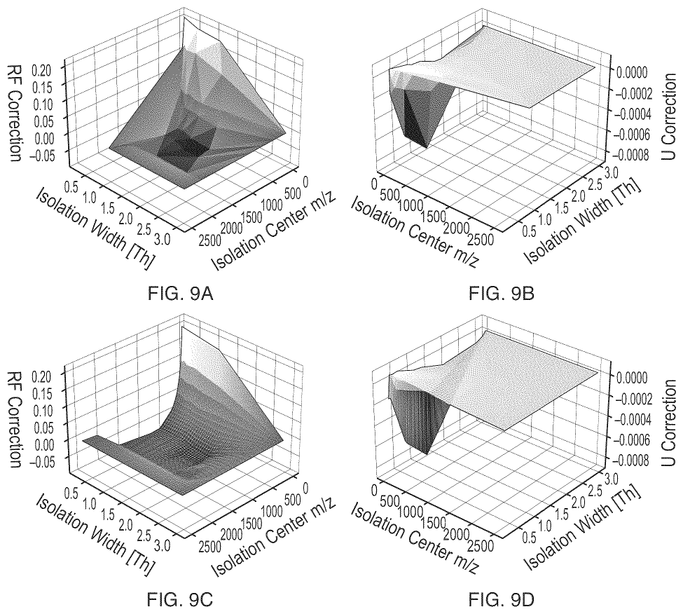

FIGS. 9A-9B show typical correction surfaces for RF and U, respectively, without interpolation; that is, simply a surface representation of the measured data points. FIGS. 9C-9D show the result of linear interpolation of the data points in FIGS. 9A-9B, respectively.

To ensure sufficient coverage of the mass-width correction space, such that accurate RF and U adjustment values are returned via interpolation during instrument operation, a large amount of data must be acquired. Typically, 30 isolation profiles, about ˜7.5 minutes of measurement time, are required per ion polarity and rod configuration. In total, 30 minutes of measurement time is taken just for this purpose.

In embodiments, the interpolated look-up table implementation is replaced with a 2-dimensional GPR representation.

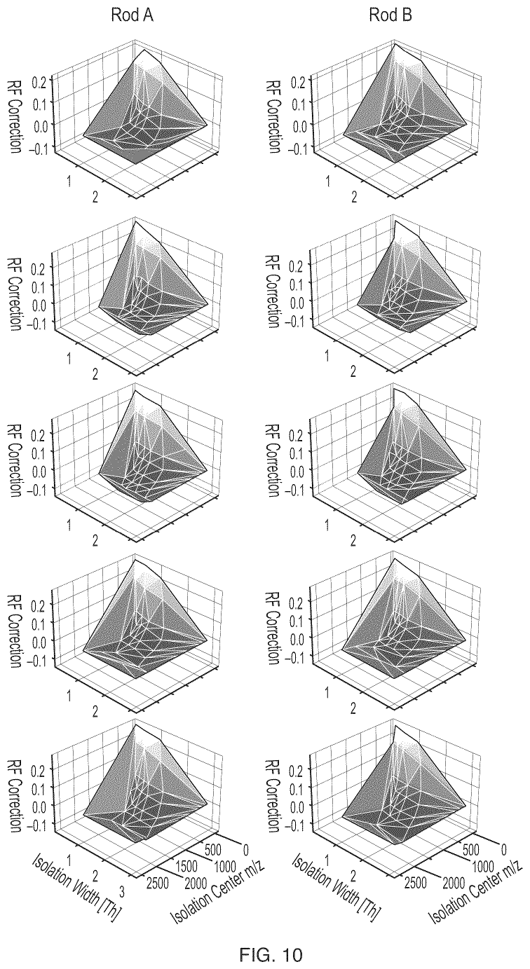

A production database of over 1300 instruments has demonstrated that the correction surfaces for RF and U are generally similar across instruments and quadrupoles for a given ion polarity. FIG. 10 illustrates the high similarity between the RF correction surfaces for five randomly selected instruments/quadrupoles for both rod configurations. This production information can thus serve as a prior for a 2-dimensional GPR representation of the RF and U correction spaces.

Replacing the interpolated look-up table implementation with a 2-dimensional GPR representation reduces the measurement burden on a particular instrument (and overall calibration time), while also enabling estimation of regions of higher correction uncertainty which can be addressed with targeted measurement approaches.

It will be appreciated that various other embodiments are possible.

In general, embodiments use parameter free regression results based on the GP framework for calibrations of analytical instruments. Embodiments involve combining covariance kernels according to expected length scales, discontinuities in real data and asymptotic properties of our instrument data.

Embodiments use prior information, if available in good quality, from previous measurements as a non-constant prior mean to enhance speed and reliability in the GPR framework. The use of non-constant prior mean functions (as an alternative or complementary approach to the use of specialised custom kernels) to obtain speed-up and better generalisation properties is not directly supported in the API and standard workflows of the most widely known packages. The usual approach in the machine learning art differs and rather relies on the use of customised kernels and combinations thereof.

Embodiments also use the GPR framework as outlined above to validate and cross-validate parametrised models in cases where they are still needed but their generalisability or applicability is doubtful.

Referring again to the example of FIGS. 7A-7B, visibly, the GPR workflow directly finds an equivalently accurate regression line without specifying any further details about the physical process that generated the data points.

As the three model fit parameters a, b, v₀ are not used directly in this calibration, and the regression curve itself is only needed (or even parts of it, corresponding to fixed masses or mass regions) in the sense of a lookup table, both results are of equal value. However, in contrast to the GPR fit (that was established after finishing the model-finding process for the problem at hand), the following steps must be completed to find a suitable heuristic model:
1. Data acquisition by a relatively tedious and involved experimental workflow;
2. Extensive (and inconclusive) literature review, with the results that no established model exists over the whole mass/velocity range under consideration;
3. Estimate the noise contribution in the recorded ion conversion data;
4. Perform fits to several heuristic models (piecewise and global) with different regression libraries, regression settings and boundary conditions;
5. Correct the model and repeat all steps above when necessary (i.e., record new data points/measurements in some regions, removed bugs in data processing pipeline from instrument to offline data lead to worse fit results).

Furthermore, it is common only to have a very limited, and sometimes difficult to generalise set of measurements available. If new data (e.g. obtained during an instrument development process or at a later stage, e.g., long-term experience from beta or final customers) renders an extension of the model necessary, this process would have to be started again.

A significant part of these issues can be circumvented by directly using the data driven GPR framework described herein. In addition, the known results from the previously performed GPR fits may be used as prior information to improve the model accuracy and/or speed up the calibration process itself by having to use fewer data points.

Although various particular embodiments have been described above, various further embodiments are possible.

In general, the approach may be applied to higher dimensional problems (e.g., a calibration dependent on several variables such as several voltages). In these case, closed-form models are even more complicated to find and more ambiguous, while independently scanning through such high-dimensional parameter space is also much more time-consuming. The exploration of the parameter space and the visualisation of the results for quality control also poses considerable problems that must be tackled with state-of-the-art approaches. These issues can, at least in part, be addressed by using the data driven GPR framework described herein.

Although the present invention has been described with reference to various embodiments, it will be understood that various changes may be made without departing from the scope of the invention as set out in the accompanying claims.

1. A method of determining a calibration model for an analytical instrument, the method comprising:
receiving mass spectral data, wherein the mass spectral data is generated by analysing one or more calibration samples using an analytical instrument;
processing the mass spectral data to produce processed data indicative of one or more properties of the analytical instrument; and
determining a calibration model for the analytical instrument by performing Gaussian Process Regression (GPR) on the processed data.

2. The method of claim 1, wherein the step of performing Gaussian Process Regression on the processed data comprises performing Gaussian Process Regression (GPR) on a difference between the processed data and a prior mean function, wherein the prior mean function comprises a previous calibration model for the analytical instrument or an average of previous calibration models for the analytical instrument.

3. The method of claim 1, wherein the step of performing Gaussian Process Regression (GPR) on the processed data utilises one of more of the Matérn covariance function(s).

4. The method of claim 1, further comprising storing the calibration model for use to (i) control an analytical instrument and/or (ii) correct data produced by an analytical instrument.

5. The method of claim 1, wherein the calibration model determined by performing Gaussian Process Regression on the processed data is a first calibration model, and the method further comprises:
determining one or more second calibration model(s) for the analytical instrument by fitting one or more model function(s) to the processed data;
comparing the one or more second calibration model(s) to the first calibration model;
selecting one of the one or more second calibration model(s) for use based on the comparison; and
storing the selected calibration model for use to (i) control an analytical instrument and/or (ii) correct data produced by an analytical instrument.

6. A method of operating an analytical instrument comprising:
using a calibration model determined according to claim 1 when operating the analytical instrument.

7. The method of claim 6, wherein the analytical instrument is operated using a plurality of operational parameters, and wherein the step of using the calibration model when operating the analytical instrument comprises determining, using the calibration model, one or more operational parameter(s) for operating the analytical instrument.

8. The method of claim 7, wherein the step of using the calibration model when operating the analytical instrument comprises determining, using the calibration model, a plurality of different sets of the one or more operational parameter(s) for operating the analytical instrument at each of a plurality of different times.

9. A method of processing mass spectral data generated by an analytical instrument, the method comprising:
receiving mass spectral data generated by analysing a sample with an analytical instrument;
processing the mass spectral data to produce processed data indicative of one or more properties of the sample; and
applying a calibration model to the processed data, wherein the calibration model is a calibration model determined using the method of claim 1.

10. The method of claim 1, wherein the analytical instrument is a mass spectrometer comprising a mass analyser.

11. The method of claim 10, wherein the mass analyser is a time-of-flight (ToF) mass analyser, an electrostatic ion trap mass analyser, an ion trap mass analyser, or a quadrupole mass analyser.

12. The method of claim 10, wherein the mass analyser is a multi-reflection time-of-flight (MR-ToF) mass analyser.

13. The method of claim 10, wherein the analytical instrument comprises an ion trap configured to inject packets of ions into the mass analyser.

14. The method of claim 1, wherein:
the mass spectral data generated by analysing one or more calibration samples is generated by using the analytical instrument to analyse a plurality of single ions;
the step of processing the mass spectral data to produce processed data indicative of one or more properties of the analytical instrument comprises generating single ion area (SIA) data by determining the area of each ion peak of a plurality of ion peaks generated by the analytical instrument in response to detecting the plurality of single ions; and
the step of determining a calibration model for the analytical instrument comprises determining a correction function by performing Gaussian Process Regression on the SIA data.

15. The method of claim 9, wherein:
the step of receiving mass spectral data generated by analysing a sample comprises receiving a signal generated by a mass analyser of the analytical instrument, wherein the signal includes one or more ion peaks;
the step of processing the mass spectral data to produce processed data indicative of one or more properties of the sample comprises determining the area of a first ion peak of the one or more ion peaks; and
the step of applying a calibration model to the processed data comprises: estimating the number of ions that contributed to the first ion peak by: (i) determining a correction to be applied to the area of the first ion peak from a correction function, wherein the correction function describes a relationship between average single ion area and ion mass (m), mass-to-charge ratio (m/z) and/or charge (z) for the mass analyser; and (ii) applying the correction to the area of the first ion peak.

16. The method of claim 1, wherein:
the step of processing the mass spectral data to produce processed data indicative of one or more properties of the analytical instrument comprises generating mass shift data by determining differences between the mass spectral generated by analysing the one or more calibration samples and mass spectral data for the one or more calibration samples that is known to be accurate; and
the step of determining a calibration model for the analytical instrument comprises determining a correction function by performing Gaussian Process Regression on the mass shift data.

17. The method of claim 9, wherein:
the step of receiving mass spectral data generated by analysing a sample with an analytical instrument further comprises receiving and/or determining an ion abundance associated with the mass spectral data, and receiving and/or determining a value of at least one trapping parameter associated with the mass spectral data;
the step of processing the mass spectral data to produce processed data indicative of one or more properties of the sample comprises processing the mass spectral data to produce mass spectral data indicative of one or more ion peaks each having a mass to charge ratio; and
the step of applying a calibration model to the processed data comprises correcting the mass spectral data by: (i) determining, from a correction function and based on the ion abundance and the value of the at least one trapping parameter, a correction to be applied to each ion peak of the one or more ion peaks; and (ii) applying the correction to each of the ion peaks.

18. The method of claim 1, wherein:
the analytical instrument comprises a quadrupole mass filter;
the mass spectral data generated by analysing one or more calibration samples is generated by using the quadrupole mass filter to measure a plurality of quadrupole isolation profiles;
the step of processing the mass spectral data to produce processed data indicative of one or more properties of the analytical instrument comprises determining one or more fine adjustment coefficients from the plurality of quadrupole isolation profiles; and
the step of determining a calibration model for the analytical instrument comprises performing Gaussian Process Regression (GPR) on the fine adjustment coefficients.

19. The method of claim 6, wherein:
the analytical instrument comprises a quadrupole mass filter; and
the step of using the calibration model when operating the analytical instrument comprises determining, using the calibration model, an RF voltage and/or a DC/RF voltage ratio (U) to apply to the quadrupole mass filter.

20. A control system for an analytical instrument, the control system configured to cause the analytical instrument to perform the method of claim 1.
